(19) United States
(12) Patent Application Publication
(10) Pub. No.: US 2008/0210197 A1
(43) Pub. Date: Sep. 4, 2008

(54) Method for exhaust gas temperature control via engine braking in an internal combustion engine

(76) Inventor: David B. Smith, Westfield, MA (US)

Correspondence Address: KELLEY DRYE & WARREN LLP, 3050 K STREET, NW, SUITE 400, WASHINGTON, DC, 20007, US

(21) Appl. No.: 12/071,110

(22) Filed: Feb. 15, 2008

Related U.S. Application Data
(60) Provisional application No. 60/902,339, filed on Feb. 21, 2007.

(51) Int. Cl. F02D 13/04

(52) U.S. Cl. 123/321; 123/323; 60/320

(57) ABSTRACT

Systems for, and methods of, controlling exhaust gas temperature in a multi-cylinder internal combustion engine during positive power operation of the engine are disclosed. Control of exhaust gas temperature may be desired to improve emissions performance in the engine, which is often dependent upon exhaust gas temperature. One or more temperature probes may be used to first determine the actual exhaust gas temperature of the engine while it is operated in a positive power mode. Next, an ECM or similar device may be used to determine a temperature difference between the actual exhaust gas temperature and a desired exhaust gas temperature for emissions performance. Based on the determined temperature difference, one or more cylinders of the engine may continue to be operated in positive power mode while one or more cylinders of the engine are switched to operating in a selected engine braking mode. The operation of some cylinders in positive power mode while operating other cylinders in engine braking mode may cause the actual exhaust gas temperature to change and more closely match the desired exhaust gas temperature.

### FIELD OF THE INVENTION

The present invention relates to methods of using engine braking (i.e., engine retarding) to control exhaust gas temperature in an internal combustion engine in order to provide improved emission after treatment of the exhaust gas.

### BACKGROUND OF THE INVENTION

Valve actuation in an internal combustion engine is required in order for the engine to produce positive power, as well as to produce engine braking. During positive power, intake valves may be opened to admit air (and fuel if no fuel injectors are provided) into a cylinder for combustion. The exhaust valves may be opened to allow combustion gas to escape from the cylinder.

During engine braking, the exhaust valves may be selectively opened to convert, at least temporarily, an internal combustion engine into an air compressor. This air compressor effect may be accomplished by opening one or more exhaust valves near piston top dead center position for compression-release type braking, or by maintaining one or more exhaust valves in a partially open position for much or all of the piston motion for bleeder type engine braking. In doing so, one or more cylinders of the engine may develop retarding horsepower to help slow the vehicle down. This can provide the operator increased control over the vehicle and substantially reduce wear on the service brakes of the vehicle. A properly designed and adjusted engine brake can develop retarding horsepower that is a substantial portion of the operating horsepower developed by the engine in positive power. Because of the significant value of such engine brakes, many large commercial vehicles, such as trucks and buses, are equipped with engine brakes, or components which allow the positive power valve actuators to operate in an engine braking mode.

For both positive power and engine braking applications, the engine cylinder intake and exhaust valves may be opened and closed by fixed profile cams in the engine, and more specifically by one or more fixed lobes which may be an integral part of each of the cams. The use of fixed profile cams makes it difficult to adjust the timings and/or amounts of engine valve lift needed to optimize valve opening times and lift for various engine operating conditions, such as different engine speeds.

One method of adjusting valve timing and lift, given a fixed cam profile, has been to incorporate a “lost motion” device in the valve train linkage between the valve and the cam. Lost motion is the term applied to a class of technical solutions for modifying the valve motion dictated by a cam profile with a variable length mechanical, hydraulic, or other linkage means. In a variable valve actuation lost motion system, a cam lobe may provide the “maximum” (longest dwell and greatest lift) motion needed for a full range of engine operating conditions. A variable length system may then be included in the valve train linkage, intermediate of the valve to be opened and the cam providing the maximum motion, to subtract or lose part or all of the motion imparted by the cam to the valve. While a lost motion system is not necessarily required to provide an engine braking mode of operation in combination with a positive power mode of engine operation, it is one well-known method of doing so.

Such a variable length system (or lost motion system) may, when expanded fully, transmit all of the cam motion to the valve, and when contracted fully, transmit none or a partial amount of the cam motion to the valve. Examples of such systems and methods are provided in Vorih et al., U.S. Pat. No. 5,829,397 (Nov. 3, 1998), Hu, U.S. Pat. No. 6,125,828, and Hu U.S. Pat. No. 5,537,976, which are assigned to the same assignee as the present application, and which are incorporated herein by reference.

In some lost motion systems, an engine cam shaft may actuate a master piston which displaces fluid from its hydraulic chamber into a hydraulic chamber of a slave piston. The slave piston in turn acts on the engine valve to open it. The lost motion system may include a solenoid valve and a check valve in communication with a hydraulic circuit connected to the chambers of the master and slave pistons. The solenoid valve may be maintained in an open or closed position in order to retain hydraulic fluid in the circuit. As long as the hydraulic fluid is retained, the slave piston and the engine valve respond directly to the motion of the master piston, which in turn displaces hydraulic fluid in direct response to the motion of a cam. When the solenoid position is changed temporarily, the circuit may partially drain, and part or all of the hydraulic pressure generated by the master piston may be absorbed by the circuit rather than be applied to displace the slave piston.

Lost motion systems, such as those described above, do not comprise all of the systems which are capable of providing engine braking in combination with positive power operation of cylinders in an engine. Other examples of such valve actuation systems, not intended to be limiting, include hydraulic common-rail valve actuation systems, completely mechanical valve actuation systems, electromechanical valve actuation systems, etc. All valve actuation systems capable of providing required valve actuation for both a positive power mode of engine operation and an engine braking mode of operation may be used in connection with the present invention.

One particular type of valve actuators of interest in connection with the present invention are variable valve actuators (VVA). Variable actuation of intake and exhaust valves in an internal combustion engine may be useful for all potential valve events (positive power and engine braking). When the engine is in positive power mode, variation of the opening and closing times of intake and exhaust valves may be used in an attempt to optimize fuel efficiency, power, exhaust cleanliness, exhaust noise, etc., for particular engine and ambient conditions. During engine braking, variable valve actuation may enhance braking power and decrease engine stress and noise by modifying valve actuation as a function of engine and ambient conditions. Moreover, VVA may enable individual engine cylinders in a multi-cylinder engine to be selected for positive power versus engine braking modes of operation.

Emissions control has become of increasing importance in modern day internal combustion engines. Failure to provide certain required levels of emission control by an engine may make the engine ineligible for sale in certain countries, regions, or states. Accordingly, there is a need to provide internal combustion engines with improved emissions control. Further, many emissions control devices require a sustained and/or periodically achieved level of exhaust gas temperature to provide a desired level of emissions control. Accordingly, there is a need for a method of engine operation which enables the engine to achieve or more closely approach a desired level of exhaust gas temperature in order to provide improved emissions control. For example, there is a need to be able to elevate engine exhaust gas temperature during periods of light engine load to allow for regeneration of particulate trap devices, which require periodic elevated exhaust gas temperatures.

Applicants have determined that the load assumed by one or more engine cylinders may be increased, thereby increasing fueling to these cylinders and increasing the resultant exhaust gas temperature in the exhaust system, by operating one or more engine cylinders in an engine braking mode while one or more of the other cylinders are operated in a positive power mode. It is therefore an advantage of some, but not necessarily all, embodiments of the present invention to provide control over exhaust gas temperatures by modifying engine valve actuation to operate one or more engine cylinders in an engine braking mode while one or more other engine cylinders continue to operate in a positive power mode. It is a further advantage of some, but not necessarily all, embodiments of the present invention to provide a selected type of engine braking in one or more individual engine cylinders while other engine cylinders are operated in a positive power mode to provide exhaust gas temperature control.

Additional advantages of various embodiments of the invention are set forth, in part, in the description that follows and, in part, will be apparent to one of ordinary skill in the art from the description and/or from the practice of the invention.

### SUMMARY OF THE INVENTION

Responsive to the foregoing challenges, Applicant has developed an innovative method of controlling exhaust gas temperature in a multi-cylinder internal combustion engine during positive power operation of the engine, comprising the steps of: operating one or more cylinders of said engine in a positive power mode; determining exhaust gas temperature for said engine while the one or more cylinders of said engine are operated in a positive power mode; and operating one or more cylinders of said engine in an engine braking mode while one or more cylinders of said engine continue to be operated in a positive power mode, wherein selection of one or more cylinders of said engine for operation in an engine braking mode is based on said determined exhaust gas temperature.

Applicant has further developed an innovative method of controlling exhaust gas temperature in a multi-cylinder internal combustion engine during positive power operation of the engine, comprising the steps of: operating one or more cylinders of said engine in a positive power mode; determining exhaust gas temperature for said engine while the one or more cylinders of said engine are operated in a positive power mode; determining a temperature difference between said determined exhaust gas temperature and a desired exhaust gas temperature; selecting one or more cylinders of said engine to be operated in a selected engine braking mode while one or more cylinders of said engine continue to be operated in a positive power mode based on said determined temperature difference; and operating the selected one or more cylinders of said engine in the selected engine braking mode while one or more cylinders of said engine continue to be operated in a positive power mode in order to control exhaust gas temperature.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a schematic diagram of a portion of an internal combustion engine with which the method embodiments of the present invention may be carried out.

FIG. 2 is a graph of an example of intake and exhaust valve actuation during a positive power mode of engine operation which may be carried out in connection with method embodiments of the present invention.

FIG. 3 is a graph of an example of exhaust valve actuation during a compression-release engine braking mode of engine operation which may be carried out in connection with method embodiments of the present invention.

FIG. 4 is a graph of an example of exhaust valve actuation during a two-cycle compression-release engine braking mode of engine operation which may be carried out in connection with method embodiments of the present invention.

FIG. 5 is a graph of an example of exhaust valve actuation during a bleeder engine braking mode of engine operation which may be carried out in connection with method embodiments of the present invention.

FIG. 6 is a graph of an example of exhaust valve actuation during a partial bleeder engine braking mode of engine operation which may be carried out in connection with method embodiments of the present invention.

FIG. 7 is a schematic diagram of an internal combustion engine, including the exhaust system, with which method embodiments of the present invention may be carried out.

### DETAILED DESCRIPTION OF EMBODIMENTS OF THE INVENTION

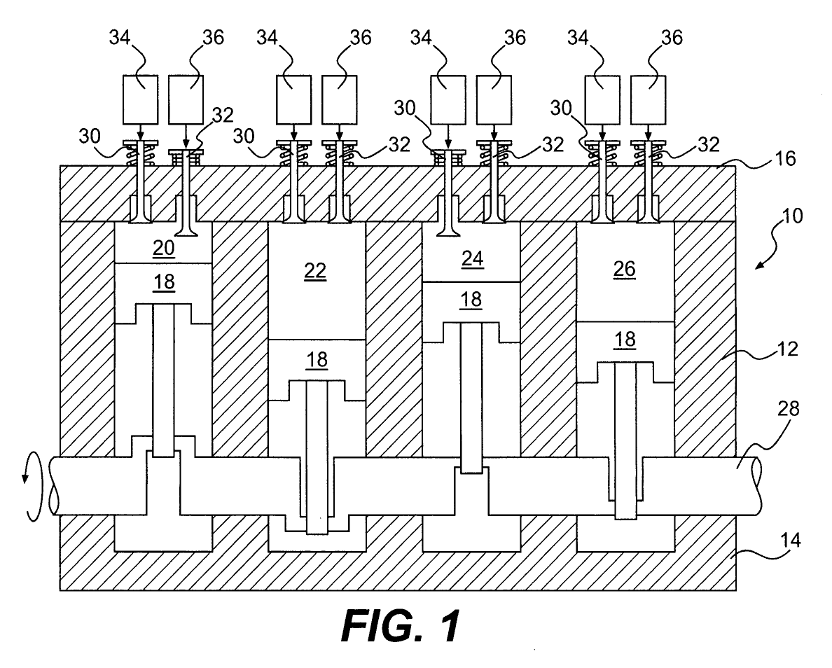

Reference will now be made in detail to a first embodiment of the present invention, an example of which is illustrated in the accompanying drawings. With reference to FIG. 1, a portion of an internal combustion engine 10 is shown. An engine, such as that shown in FIG. 1, may be used to carry out method embodiments of the present invention. The engine 10 may include a cylinder block 12, a crank case 14, and a cylinder head 16. A plurality of engine pistons 18 may be provided in a plurality of corresponding engine cylinders 20, 22, 24 and 26. A four cylinder portion of an engine is shown for illustrative purposes only. It is appreciated that embodiments of the present invention may be carried out with an engine having any number of cylinders greater than one, such as e.g., four cylinders, six cylinders, V-8 engines, etc. Each of the pistons 18 may be connected to a crank shaft 28 provided in the crank case 14.

The cylinder head 16 may include one or more intake valves 30 and one or more exhaust valves 32 for each engine cylinder. One intake valve 30 and one exhaust valve 32 are shown for illustrative purposes only; and it is appreciated that each engine cylinder may include multiple intake valves, multiple exhaust valves, and potentially a “third” valve for dedicated engine braking operation. Each of the intake and exhaust valves 30 and 32 may be spring biased upward in the drawing figure into a closed position. The intake and exhaust valves 30 and 32 may be opened by depressing them using respective intake valve actuators 34 and exhaust valve actuators 36. The intake and exhaust valve actuators 34 and 36 are shown in block form to indicate that it is appreciated that these valve actuators may comprise any number of known engine valve actuators using known types of valve train elements. It is intended that the illustrated intake and exhaust valve actuators represent any valve actuation systems capable of actuating engine valves for a positive power mode of operation and one or more modes of engine braking operation, including but not limited to compression-release engine braking, two-cycle compression-release engine braking, bleeder braking, and/or partial bleeder braking. For example, the intake and exhaust valve actuators may comprise one or a combination of a push tube, cam, rocker arm, finger follower, common rail hydraulic actuator, electromagnetic actuators, lost motion actuators, and/or any other type of hydraulic actuator.

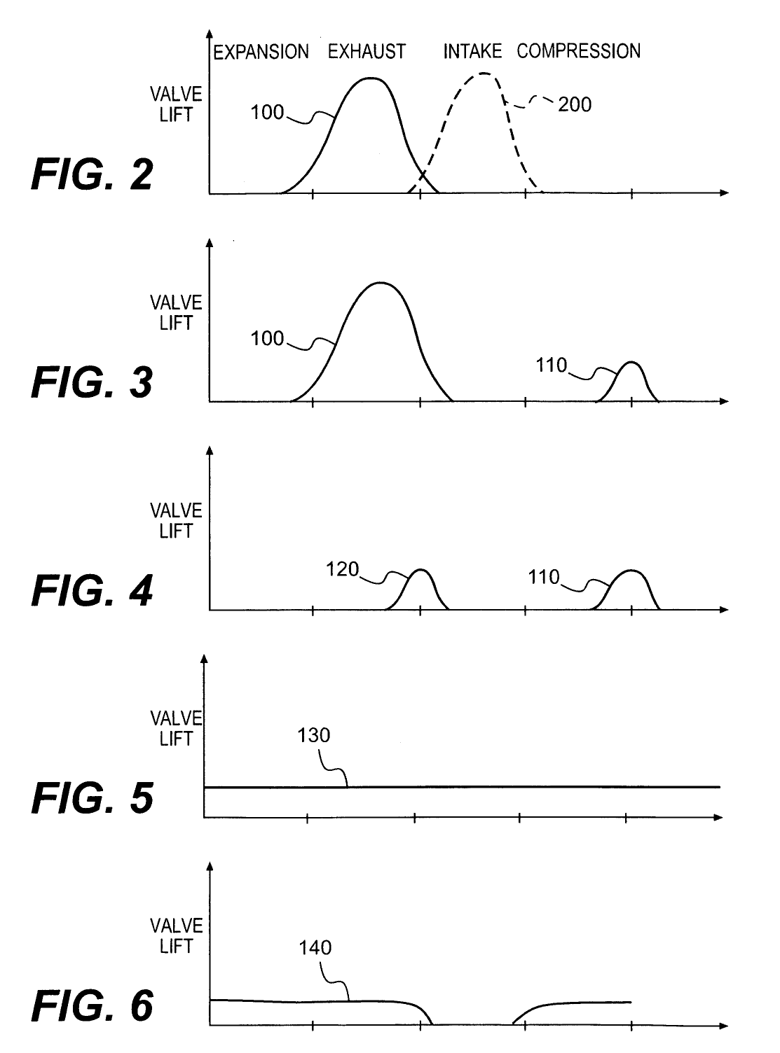

Examples of intake and exhaust valve actuations that may be provided by the intake and exhaust valve actuators 34 and 36 are shown in FIGS. 2-6. FIG. 2 illustrates a main exhaust valve actuation (or event) 100 and a main intake valve actuation (or event) 200 that may be provided during a positive power mode of engine operation in an engine cylinder wherein the exhaust valve(s) 32 may be opened during the exhaust cycle and the intake valve(s) 30 may be opened during the intake cycle. FIG. 3 illustrates exhaust valve actuation during an engine braking mode of operation in which the exhaust valve(s) 32 may be opened for the main exhaust actuation 100 and a compression-release engine braking actuation 110 near top dead center of the compression cycle. FIG. 4 illustrates exhaust valve actuation during a second engine braking mode of operation in which the exhaust valve(s) 32 may be opened for a first compression-release actuation 110 near top dead center of the compression cycle and a second compression-release actuation 120 near top dead center of the exhaust cycle. FIG. 5 illustrates exhaust valve actuation during a third engine bleeder braking mode of operation in which the exhaust valve(s) 32 may be maintained open throughout the expansion, exhaust, intake and compression cycles. FIG. 6 illustrates exhaust valve actuation during a fourth engine braking mode of operation known as partial bleeder braking, in which the exhaust valve(s) 32 may be maintained open throughout several, but not all, of the four engine cycles.

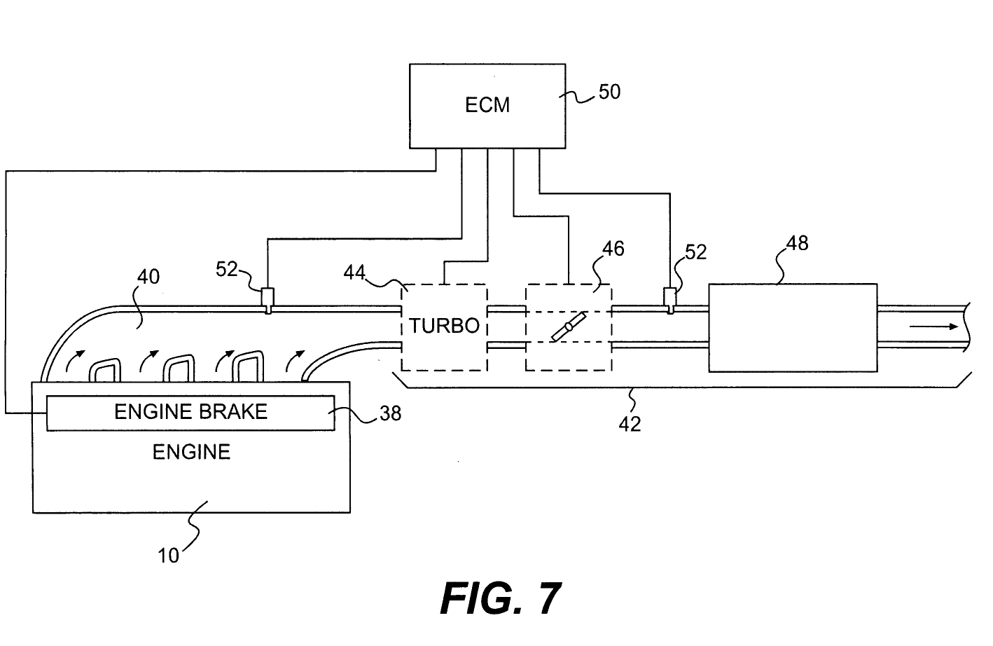

With reference to FIG. 7, the engine 10 may include an engine brake 38. It is appreciated that the engine brake 38 may comprise those portions of the exhaust valve actuators 36 which are required to carry out engine braking operation. In some engines the engine brake 38 and the exhaust valve actuators 36 may comprise the same components, while in other engines, the engine brake 38 may comprise only a subset of the exhaust valve actuators. The engine 10 may be connected to an exhaust manifold 40 which receives exhaust gas from the engine during positive power and engine braking operation. The exhaust manifold may be connected to the remainder of the exhaust system 42, which may include an optional turbo-charger 44, an optional exhaust restrictor or exhaust brake 46, and an emissions control device 48, such as a catalytic converter and/or particulate trap. One or more temperature probes 52 may be provided in the exhaust manifold 40 and/or the remainder of the exhaust system 42 to determine the actual exhaust gas temperature. The engine 10, the engine brake 38, the turbo-charger 44, the exhaust restrictor 46, and the temperature probes 52 may be connected to an engine control module (ECM) 50 or similar device.

Control over exhaust gas temperature may be achieved in a first method embodiment of the present invention during positive power operation of the engine 10. Exhaust gas temperature control may be desired in order to improve the performance of the emissions control device 48. For example, elevated exhaust gas temperatures may be required for regeneration of particulate traps and/or operation of other emissions control devices.

With continued reference to the first method embodiment of the present invention, and with reference to FIGS. 1-7, one or more cylinders of the engine 10 may be operated in a positive power mode. In positive power mode, fuel is provided to one or more of the engine cylinders 20, 22, 24 and 26, and burned during a combustion process to create positive power. At this time, the temperature probe(s) 52 and the ECM 50 may be used to determine the actual exhaust gas temperature at one or more locations in the exhaust manifold 40 and/or exhaust system 42. The location of the temperature probe(s) 52 may include the exhaust manifold 40 and a location near or in the emissions control device 48. The ECM 50 may be programmed in a manner to also determine the desired exhaust gas temperature for the engine 10 at the time in question. The desired exhaust gas temperature may be determined from any number of parameters, such as engine operation history, present location, present load, particulate trap regeneration requirements, etc. The ECM 50 may compare the actual exhaust gas temperature with the desired exhaust gas temperature to determine a temperature difference.

If the desired exhaust gas temperature is greater than the actual exhaust gas temperature, the ECM 50 may vary valve actuation in, and fueling to, one or more engine cylinders 20, 22, 24 and 26, to increase the exhaust gas temperature. For example, with reference to FIG. 1, if the desired exhaust gas temperature is greater than the actual temperature, the ECM 50 may cause the cylinders 20 and 24 to continue to operate in a positive power mode, and cause the cylinders 22 and 26 to cease operating in a positive power mode and begin to operate in a selected engine braking mode. Specifically, the ECM 50 may cease the injection of fuel to the cylinders 22 and 26 and begin to cause the exhaust valve 32 in each of the cylinders 22 and 26 to be actuated in accordance with one or more of the engine braking valve actuations illustrated in FIGS. 3-6, such as compression-release braking, bleeder braking, etc. As a result, the load assumed by cylinders 20 and 24 may be increased, thereby increasing fueling to these cylinders and increasing the resultant exhaust gas temperature in the exhaust manifold 40 and/or exhaust system 42. The selection of which engine cylinders 20, 22, 24 and 26 are operated in a positive power mode versus an engine braking mode, as well as the selection of the type of engine braking mode (i.e., compression-release, two-cycle compression-release, bleeder braking, etc.) selected for some of the cylinders, may be made by the ECM 50 based on the difference between the actual exhaust gas temperature and the desired exhaust gas temperature in conjunction with other parameters, such as engine operation history, engine location (i.e., longitude, latitude, and altitude), engine components (i.e., presence and operation of a turbo-charger 44 and/or an exhaust restrictor 46), etc.

The exhaust gas temperature may continue to be monitored, and the selection of engine cylinders for a positive power mode of operation versus an engine braking mode of operation may be varied as required to maintain or achieve the desired exhaust gas temperature. Further, the operation of the optional turbo-charger 44 and/or the optional exhaust restrictor 46 may be modified by the ECM 50 in a manner to permit the engine 10 to achieve the desired exhaust gas temperature. For example, the exhaust restrictor 46 may be closed or partially closed in combination with operating one or more of the cylinders in an engine braking mode to increase exhaust gas temperature.

It will be apparent to those of ordinary skill in the art that variations and modifications of the present invention can be made without departing from the scope or spirit of the invention.

What is claimed is:

1. A method of controlling exhaust gas temperature in a multi-cylinder internal combustion engine during positive power operation of the engine, comprising the steps of:
operating one or more cylinders of said engine in a positive power mode;
determining an exhaust gas temperature for said engine while the one or more cylinders of said engine are operated in a positive power mode; and
operating one or more cylinders of said engine in an engine braking mode while one or more cylinders of said engine continue to be operated in a positive power mode,
wherein selection of the one or more cylinders of said engine for operation in an engine braking mode is based on said determined exhaust gas temperature.

2. The method of claim 1, further comprising the step of:
comparing said determined exhaust gas temperature with a desired exhaust gas temperature in order to select the one or more cylinders of said engine to be operated in an engine braking mode.

3. The method of claim 1 wherein the engine braking mode is a compression-release engine braking mode.

4. The method of claim 1 wherein the engine braking mode is a two-cycle compression-release engine braking mode.

5. The method of claim 1 wherein the engine braking mode is a bleeder braking mode.

6. The method of claim 1 wherein the engine braking mode is a partial bleeder braking mode.

7. The method of claim 1 further comprising the step of:
restricting exhaust gas flow from said engine during positive power operation of the engine based on said determined exhaust gas temperature.

8. The method of claim 1 wherein two of said cylinders in said engine are operated in an engine braking mode, and wherein the type of engine braking carried out in said two cylinders is different from each other.

9. The method of claim 8 wherein the different types of engine braking are compression-release engine braking and bleeder braking.

10. The method of claim 1 wherein exhaust gas temperature is determined in a particulate trap device.

11. The method of claim 1 wherein exhaust gas temperature is determined in an exhaust manifold.

12. The method of claim 1 wherein exhaust gas temperature is determined in more than one location is an exhaust system of said engine.

13. The method of claim 1, further comprising the step of:
modifying operation of a turbo-charger provided in said engine based on said determined exhaust gas temperature.

14. A method of controlling exhaust gas temperature in a multi-cylinder internal combustion engine during positive power operation of the engine, comprising the steps of:
operating one or more cylinders of said engine in a positive power mode;
determining an exhaust gas temperature for said engine while the one or more cylinders of said engine are operated in a positive power mode;
determining a temperature difference between said determined exhaust gas temperature and a desired exhaust gas temperature;
selecting one or more cylinders of said engine to be operated in a selected engine braking mode while one or more cylinders of said engine continue to be operated in a positive power mode based on said determined temperature difference; and
operating the selected one or more cylinders of said engine in the selected engine braking mode while one or more cylinders of said engine continue to be operated in a positive power mode in order to control exhaust gas temperature.

15. The method of claim 14, wherein the engine braking mode is selected from the group consisting of: compression-release engine braking, two-cycle compression-release engine braking, bleeder braking, and partial bleeder braking.
